(19) United States
(12) Patent Application Publication
(10) Pub. No.: US 2018/0147708 A1
(43) Pub. Date: May 31, 2018

(54) LATCH MECHANISM FOR RETAINING AND REMOVING A VALVE BODY OF A HYDRAULIC HAMMER

(71) Applicant: Caterpillar Inc., Peoria, IL (US)

(72) Inventors: Joshua Grzybowski, Waco, TX (US); Cody Moore, Waco, TX (US)

(73) Assignee: Caterpillar Inc., Peoria, IL (US)

(21) Appl. No.: 15/363,941

(22) Filed: Nov. 29, 2016

(51) Int. Cl. B25D 9/04; F16K 27/00

(52) U.S. Cl. CPC B25D 9/04; B25D 2209/002; F16K 27/00

(57) ABSTRACT

A method of retaining and removing a valve locking body from a powered hammer assembly comprises inserting a locking member into a radially extending aperture of a cylinder, inserting a spring until the spring contacts the locking member; and inserting a keeper radially inwardly of the spring and the locking member and attaching the keeper to the cylinder.

### TECHNICAL FIELD

The present disclosure relates to hydraulic hammers and other work tools that use a compressed gas to power the movement of tools. More specifically, the present disclosure relates to devices and methods for releasing a compressed gas from such tools and disassembling such tools.

### BACKGROUND

Hydraulic hammers are generally known to include a tool extending partially out of a housing. Such hammers may include a hydraulically actuated power cell having an impact system operatively coupled to the tool. The impact system generates repeated, longitudinally directed forces against a proximal end of the tool disposed inside the housing. The distal end of the tool, extending outside of the housing, may be positioned against rock, stone, or other materials, thereby to break up those materials. During operation, the hydraulic hammer will form large pieces of broken material as well as stone dust and fine grit.

Many hydraulic hammers or other types of powered hammers use a compressed gas or other type of compressed fluid. In many applications, compressed nitrogen is used that is found above the piston in the accumulator that is important for the correct operation of the hammer. In particular, the presence of the nitrogen is important for providing the desired blow or impact energy and hydraulic efficiency of the hammer. Over time, the nitrogen may leak. Alternatively, an event that causes damage to the hammer may cause some leakage of the nitrogen charge or some other component of the hammer may need replacement or rework.

Therefore, it is necessary to perform maintenance on such hydraulic hammers periodically that may necessitate the disassembly of the hammer by removing the valve body positioned over the gas. Disassembly of the valve body from the hydraulic hammer requires the use of a tool in many applications. Such tools may not be available in the field or may get lost, making removal of a valve body impractical.

### SUMMARY OF THE DISCLOSURE

A locking valve body assembly for use with a powered hammer assembly is provided. The valve body assembly comprises a valve body that defines a circumferential direction, a radial direction and a longitudinal axis, a void configured to contain a pressurized fluid, a cylinder configured to receive the valve body, the cylinder defining a radially extending locking aperture on it circumferential surface, and a latch mechanism including a radially extending locking member, a spring biasing the locking member into the radially extending locking aperture of the cylinder, and an actuator configured to move the locking member radially inward.

A powered hammer assembly is provided comprising a housing, a power cell that includes a piston, and a locking valve body assembly that includes: a valve body that defines a void that is configured to contain a pressurized fluid, a latch mechanism including a locking member and a spring configured to bias the locking member radially into a locking configuration, and a retainer member. The housing defines a first aperture that is configured to receive the locking member, and wherein the housing further defines a retaining slot that is configured to receive the retainer member.

A method of retaining and removing a valve locking body from a powered hammer assembly is provided. The method may comprise inserting a locking member into a radially extending aperture of a cylinder, inserting a spring until the spring contacts the locking member, and inserting a keeper radially inwardly of the spring and the locking member and attaching the keeper to the cylinder.

### BRIEF DESCRIPTION OF THE DRAWINGS

FIG. 1 is a top view of a locking valve body assembly that includes a latch mechanism according to various embodiments of the present disclosure shown in a locked configuration.

FIG. 2 is a cross-sectional view of the locking valve body assembly of FIG. 1 taken along lines 2-2 thereof.

FIG. 3 is an enlarged detail view of area 3 of FIG. 2, showing the latch mechanism according to one embodiment of the present disclosure in more detail.

FIG. 4 is a is a top view of the locking valve body assembly and latch mechanism of FIG. 1 shown in an unlocked configuration.

FIG. 5 is a front view of an excavating machine using a hydraulic hammer assembly that uses a locking valve body assembly with a latch mechanism according to various embodiments of the present disclosure.

FIG. 6 is a perspective view of the hydraulic hammer assembly and part of the stick of the machine of FIG. 7 shown in isolation from the machine.

FIG. 7 is a perspective view of the hydraulic hammer assembly of FIG. 6 with part of the exterior housing removed, showing more clearly the tie rods that hold the assembly together, the power cell, and the locking valve body assembly.

FIG. 8 is a flowchart depicting a method of retaining and removing a valve locking body according to an embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In some cases, a reference number will be indicated in this specification and the drawings will show the reference number followed by a letter for example, 100a, 100b or a prime indicator such as 100′, 100″ etc. It is to be understood that the use of letters or primes immediately after a reference number indicates that these features are similarly shaped and have similar function as is often the case when geometry is mirrored about a plane of symmetry. For ease of explanation in this specification, letters or primes will often not be included herein but may be shown in the drawings to indicate duplications of features discussed within this written specification.

A hydraulic hammer assembly or other powered hammer or powered tool assembly may include a latching mechanism that may or may not need the use of tools to retain or remove a valve body from the assemblies. Various embodiments of the latch mechanism will now be described.

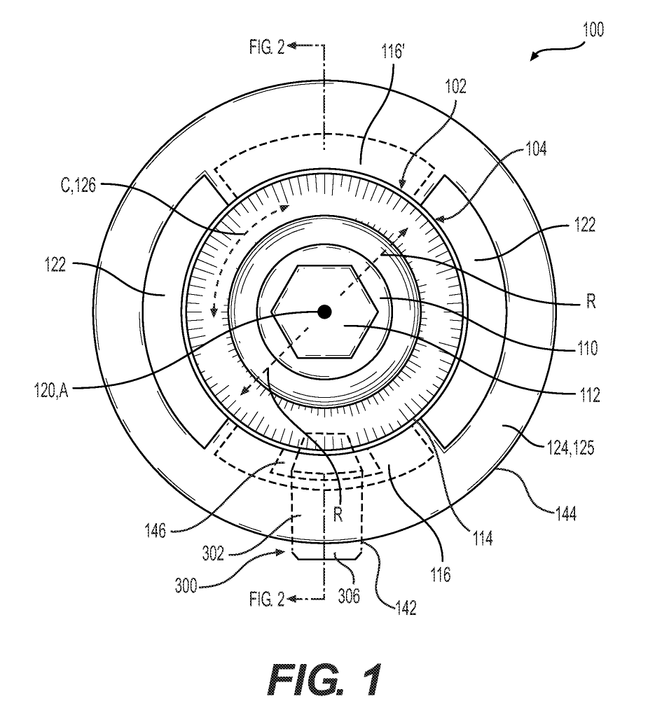

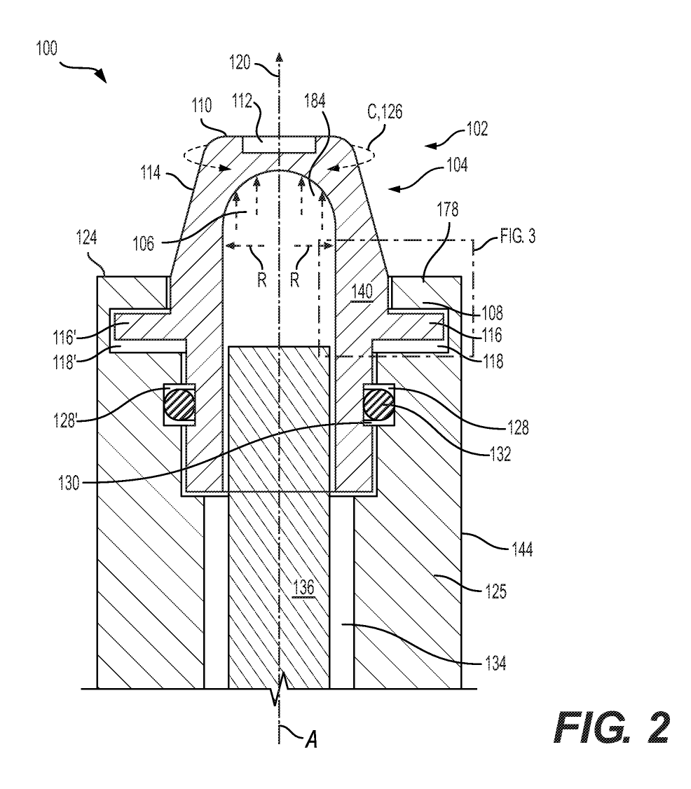

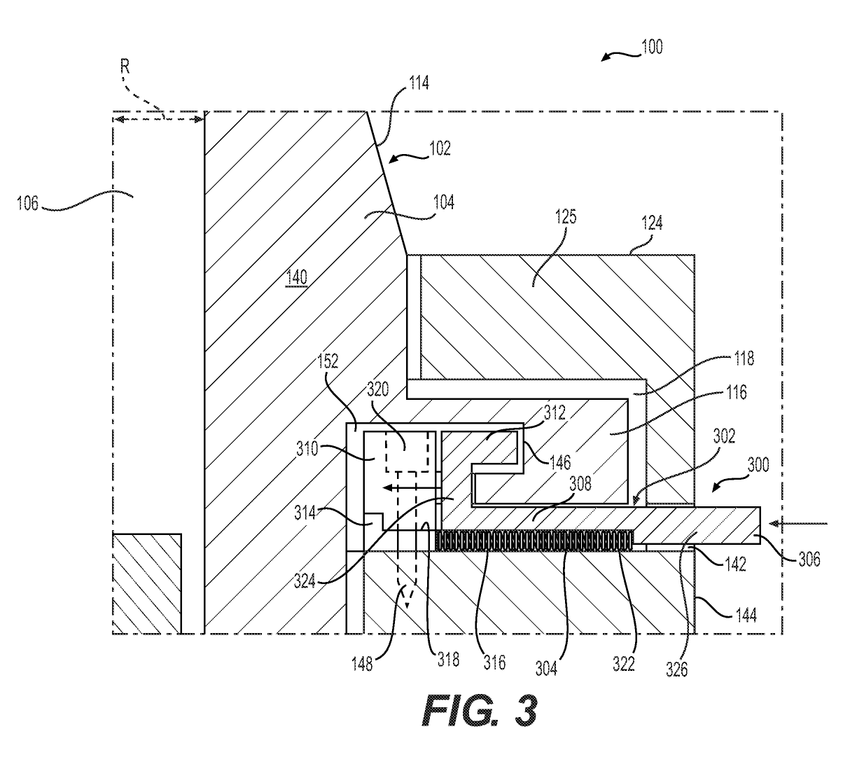

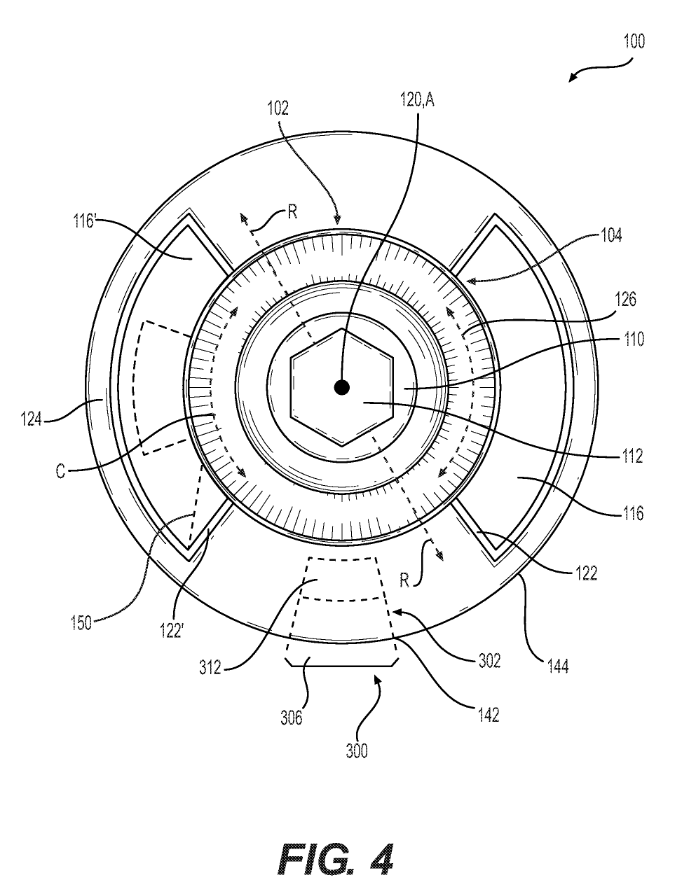

Looking at FIGS. 1 and 2, a locking valve body assembly 102 for use with a powered tool assembly 100 that uses a pressurized fluid can be seen that includes a valve body 104 that defines a void 106 configured to contain a pressurized fluid and a latch mechanism 300 including a locking member 302 that is configured to be biased by a spring 304 (best seen in FIG. 3) into a locking configuration. The valve body 104 may include a top surface 110 that defines a hexagonal pocket 112 that provides a drive structure for rotating the locking valve body assembly 102 from the locked configuration as shown in FIG. 1, to an unlocked configuration as will be described with reference to FIG. 4 later herein. Other types of drive structures that are known or that will be devised in the art could also be used such as wrench or torx configurations, etc. Alternatively, the exterior perimeter 114 of the valve body 104 itself could be knurled or provided with other gripping features to allow movement of the locking valve body assembly 102 manually without the need of a tool.

Focusing on FIG. 1, the locking valve body assembly 102 further comprises a retainer member or flange 116 (shown by hidden lines) that is configured to mate with a corresponding feature of a powered tool assembly 100 such as a retaining slot 118 (see FIG. 2), preventing the locking valve body assembly 102 from being removed from the power tool assembly 100 along a first predetermined direction 120. Slots 122 are defined by the top surface 124 of the housing or cylinder 125 that allow removal of the locking valve body assembly 102 when the retaining members 116 are aligned with the slots 122 as best seen in FIG. 4. For this embodiment, the locking valve body assembly 102, retainer member 116 and housing 125 are substantially cylindrical, defining an axis A of rotation. However, other configurations and directions of movement are possible for other embodiments of the present disclosure. Looking at FIGS. 1 and 2, the housing 125 of the power tool assembly 100 and the locking valve body assembly 102 also define a radial direction R and a circumferential direction C, which would also correspond to the directions 126 of rotation of the locking valve body assembly 102. The radial direction R is perpendicular to the axis A of rotation and to the tangent of the circumferential direction C. Accordingly, all three directions are different one from another.

Looking at FIG. 2, the housing 125 and valve body 104 also define slots 128, 130 that receive an O-ring 132 or other type of seal that prevent the escape of the pressurized fluid contained in the locking valve body assembly 102 or the housing 124. As used herein, a “fluid” is defined in a manner consistent with classic fluid mechanics, and includes gases and liquids of all types that deform continuously as a shear stress is applied to them. A piston 136 is disposed in the central bore 134 of the housing 124 and the void 106 of the valve member assembly 102 in a manner known in the art.

Turning the reader's attention now to FIG. 3, an embodiment of a latching mechanism 300 according to a first embodiment of the present disclosure may be more clearly seen. The retainer member 116 extends from the main wall 140 of the valve body 104 in the radial direction R into the retaining slot 118 that is at least partially complimentary shaped to the retainer member 116. The retaining slot 118 is defined by the sidewall 142 of the housing 124. A spring 304 is shown that is configured to bias the locking member 108 into the locking configuration.

As mentioned previously, FIG. 3 shows that the valve body 104 defines a circumferential direction C, a radial direction R and a longitudinal axis A (best seen in FIG. 2), and a void 106 configured to contain a pressurized fluid. The valve body 104 mates with a cylinder 125 configured to receive the valve body 104, the cylinder defining a radially extending locking aperture 142 on it circumferential surface 144 and a radially extending locking member 302 extends through the aperture 142. More particularly, the spring 304 biases the locking member 302 into the radially extending locking aperture 142 of the cylinder 125 and the locking member 302 includes an actuator 306 configured to move the locking member 302 radially inwardly when pushed radially inwardly. This may be done manually, or when the actuator is flush to recessed to the circumferential surface 144 of the cylinder 125, using a tool such as a straight slot styled screw driver or the like.

Looking more closely at the locking member 302 in FIG. 3, the locking member includes a main body 308 extending radially through the locking aperture 142 and the actuator 306 extends radially from the main body 308 past the circumferential surface 144 of the cylinder 125 and the actuator 306 is integral with the main body 308 of the locking member 302. The locking valve body assembly 102 or latch mechanism 300 may further comprising a keeper 310 disposed radially inward to the locking member 302 and being configured to limit the radial inward movement of the spring 304 and the locking member 302. Although not clearly shown, the keeper may prevent circumferential movement of the spring and locking member as well. The locking member 302 further comprises a hook portion 312 and the valve body 104 further defines a pocket 146 (also seen in FIG. 1) configured to receive the hook portion 312 of the locking member 302. As also mentioned earlier, the valve body 104 further comprises a retaining flange 116 and the retaining flange 116 defines the pocket 146 configured to receive the hook portion 312 of the locking member 302, preventing rotation of the valve body.

As can also be seen in FIG. 3, the keeper defines a ledge 314 disposed radially inward of the locking member 302, the ledge 314 being configured to abut the rear of the locking member 302 as radially inward force is exerted on the actuator 306. At the same time, the bottom surface 316 of the main body 308 of the locking member 302 would slide on a surface 318 of the keeper 310 disposed radially outwardly from the ledge 314. The keeper 310 is attached to the cylinder 125, for example, using a fastener mating with a counterbore 320 in the keeper 310 and a threaded hole 148 in the cylinder 125. Attachment may be achieved using other methods or devices known or that will be devised in the art.

For the embodiment shown in FIG. 3, the locking member 302 defines an aperture 322 configured to receive the spring 304. In this case, the aperture 322 is a slot but could be a blind hole in other embodiments, etc. Also, for this embodiment, the actuator and hook portion of the locking member both face radially outwardly. In other embodiments, the hook portion could face radially inwardly, required the user to pull radially outwardly on the locking member to unlock the latch mechanism. In such an embodiment, the spring would likely be trapped between the cylinder 125 and a portion of the locking member 302.

Referring now to FIGS. 1 thru 4, the operation of the latch mechanism 300 may be understood. The valve body 104 may be rotated in the clockwise direction as shown in FIG. 4 until a cam feature 150 of the retainer flange 116 contacts the locking member 302. The cam feature 150 may force the locking member 302 to move radially inwardly, allowing further rotation of the valve body 104 until the hook portion 312 of the locking member 302 snaps into the pocket 146 of the retainer flange 116 (see FIG. 1), urged to do so by the spring 304. To unlock, the user would press on the actuator 306 of the locking member 302 until the hook portion 312 is no longer in the pocket 146 of the retainer flange 116. Then, a clockwise rotation of the valve body 104 can continue until the unlocked configuration of FIG. 4 is achieved and the valve body 104 is removed along direction 120. The latch mechanism 300 would stay in place in the cylinder 125 due to the keeper 310.

In some embodiments, the cam feature 150 on the retainer flange 116 may be omitted. In such a case, the user would need to depress the actuator 306, moving the locking member 302 into an unlocked configuration until the hook portion 312 is aligned with the pocket 146 on the retainer flange 116, at which time, releasing the actuator 306 would lock the valve body 104 into place as the hook portion 312 engages the pocket 146 of the retainer flange 116. Then, unlocking the assembly would simply require reversing these steps.

Various embodiments of the latch mechanism, including the one shown in FIG. 3, may be described in more general terms as follows. A latch mechanism 300 may include a locking member 302 and a spring 304 configured to bias the locking member 302 radially into a locking configuration (see locking aperture 142). In some cases, this may in the radial outward direction (see FIG. 3), in other cases, this may be in the radially outward direction. A retainer member 116 may be disposed in the retaining slot 118 of housing 125. The housing 125 may define a first aperture 142 that is configured to receive the locking member 302.

With reference to FIGS. 1, 3 and 4, the valve body 104 and the retainer member 116 may define an axis of rotation A, a circumferential direction C and a radial direction R and the locking member 302 may be configured to translate in the radial direction. The valve body 104 and the retaining member 116 may be integral with each other or they may be separate pieces attached to each other via fastening, welding, etc. The retainer member 116 defines a pocket 146 that is configured to receive the locking member 302 and a circumferential slot 152 that is configured to allow the valve body 104 to rotate when the locking member 302 is not in a locking configuration.

A keeper 310 may also be provided that is disposed in the circumferential slot 152 radially inward of the spring 304 and the locking member 302. In some embodiments, the locking member 302 includes a main body portion 308 defining an inside radial end 324, a hook portion 312 extending from the inside radial end 324, an outside radial end 326, and an actuation portion 306 extending from the outside radial end 326. Other configurations of the locking member are possible.

### INDUSTRIAL APPLICABILITY

In practice, a locking valve body assembly or a latching mechanism may be sold, manufactured or otherwise provided to retrofit or repair a powered tool assembly such as a powered hammer tool assembly. Also, a new powered hammer assembly may be sold or otherwise provided using any embodiment of a locking valve body assembly or a latching mechanism as disclosed herein.

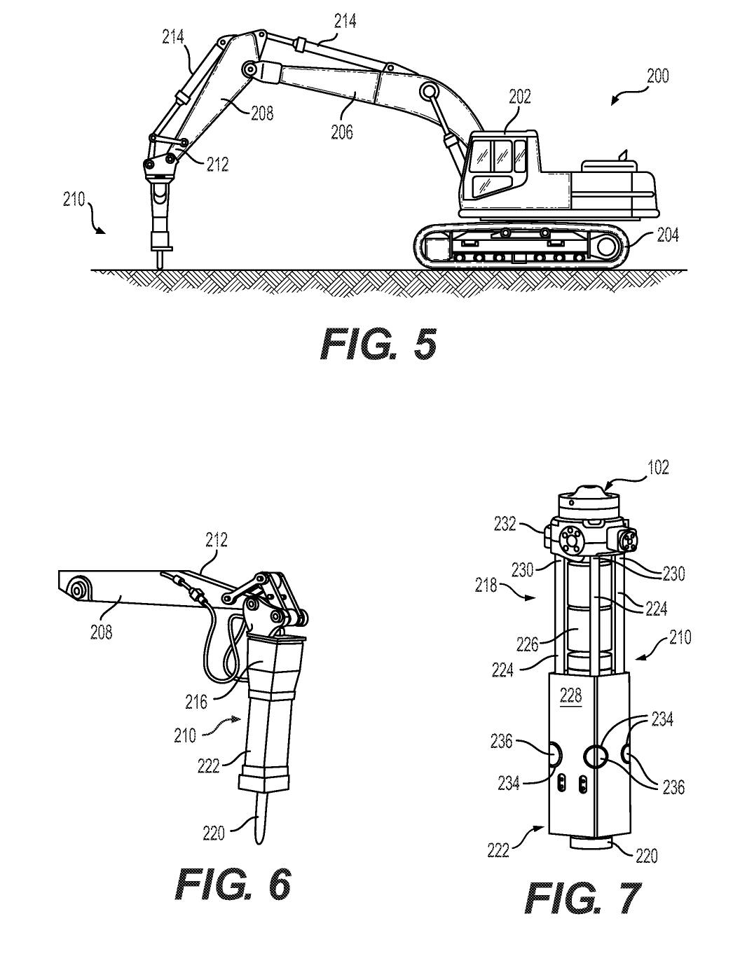

FIGS. 5 thru 7 illustrate an application of the locking valve body assembly and latching mechanism discussed thus far with reference to FIGS. 1 thru 4. Many other applications are possible and are therefore to be understood as also being within the scope of the present disclosure.

Referring initially to FIG. 5, an excavating machine 200 of a type used for digging and removing rock and soil from a construction worksite is shown. The excavating machine 200 may incorporate a cab body 202 containing an operator station, an engine, and operating controls (not depicted). The machine 200 may be supported by, and may move on, tracks 204. An extensible boom 206 may be movably anchored to the cab body 202, and an articulating stick 208, also sometimes called a lift arm, may be secured to and supported for movement on the boom 206. The excavating machine 200 may incorporate a hydraulic hammer assembly 210 as depicted, or may alternatively incorporate another implement, at an operational end 212 of the stick 208. Hydraulic cylinder actuators 214 may be utilized to move the stick 208 relative to the boom 206, and to move the hydraulic hammer assembly 210 relative to the stick 208.

Referring now also to FIG. 6, the hydraulic hammer assembly 210 may be secured to the operational end 212 of the stick 208. The hydraulic hammer assembly 210 may include an upper portion 216 that includes a power cell 218 shown below in FIG. 3 and a lower so-called front head portion 222 secured to the power cell 218. A hammer tool 220 having an upper end (not shown) may be retained within the front head portion 222. The hammer tool 220 may be adapted to produce cyclic vibrational movement at an intensity sufficient to demolish rocks, for example. The functional parts of the hydraulic hammer assembly 210, including the hammer tool 220 may be constructed of a forged or otherwise hardened metal such as a refined steel, for example, to assure appropriate strength, although other suitable materials such as diamond bits for operative portions of the hammer tool 220, for example, may be utilized within the scope of this disclosure.

Referring now also to FIG. 7, the hydraulic hammer assembly 210 is shown alone, i.e. detached from the stick 208 and with its exterior case covers removed, to reveal an exposed power cell 218, and a plurality of tie rods 224 circumferentially disposed about a cylindrical piston-containing sleeve structure 226. The sleeve structure 226 may contain a piston (not shown) adapted to drive the hammer tool 220. As such, the power cell 218 may be effective to utilize a suitable working fluid, such as a hydraulic and/or pneumatic fluid, for example, to reciprocally impact the piston against the upper end (not shown) of the hammer tool 220. It may also be appreciated that the plurality of tie rods 224 may be effective to retain or hold the power cell 218 and the front head portion 222 together under harsh impact loads as may be experienced within the hydraulic hammer assembly 210. In addition, a locking valve body assembly may be employed at the top of the hydraulic assembly as described herein.

The lower front head portion 222 may define an actual front head 228, which may function as a structural housing to support the upper end (not shown) of the hammer tool 220. An upper end 230 of each of the tie rods 224 may be secured to an upper structure or upper head 232 of the power cell 218. Each tie rod 224 may have a threaded lower end (not depicted) that extends downwardly through a vertically oriented aperture or tie rod bore 234 within the front head 222. The tie rod bore 234 defines a longitudinal axis of the installed tie rod 224. Each tie rod 224 may be adapted to be threadedly secured to a tie rod nut 236.

With continued reference to FIGS. 1 thru 4 and combining the understanding derived from them and applying it to FIGS. 5 thru 7, it can be appreciated that a powered hammer assembly 100, 210 may be provided or assembled that comprises a housing 124, a power cell 218 that includes a piston 136, and a locking valve body assembly 102 that includes a valve body 104 that defines a void 106 that is configured to contain a pressurized fluid, a locking member 108 that is configured to be biased by pressurized fluid into a locking configuration, and a retainer member 116. The housing 124 defines a first aperture 150 that is configured to receive the locking member 108, and the housing 124 further defines a retaining slot 118 that is configured to receive the retainer member 116.

In some embodiments, the valve body 104 and retainer member 116 define an axis A of rotation and a radial direction R and the locking member 108 is configured to translate in the radial direction R or along a direction that is parallel with the axis A of rotation. In other embodiments, the valve body 104 and retaining member 116 are integral with each other.

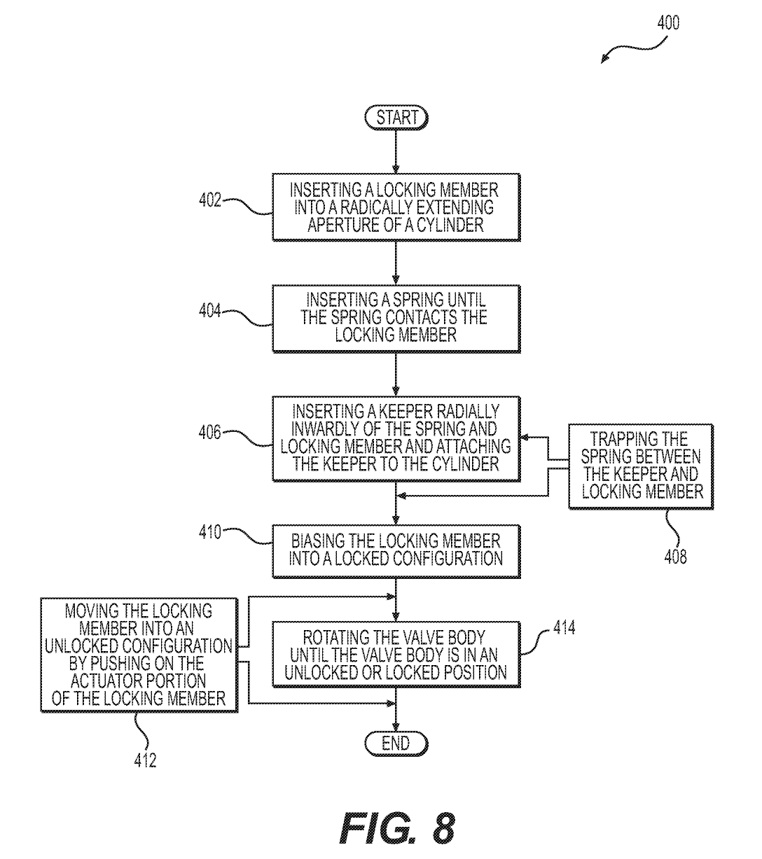

The various embodiments of the apparatus described herein may be use with a method of retaining or removing a valve body from an assembly as shown in the flowchart of FIG. 8.

The method 400 may comprise inserting a locking member into a radially extending aperture of a cylinder (see step 402), inserting a spring until the spring contacts the locking member (see step 404), and inserting a keeper radially inwardly of the spring and the locking member and attaching the keeper to the cylinder (see step 406).

In some embodiments, the method may further comprise trapping the spring between the keeper and the locking member (see step 408) and biasing the locking member into a locked configuration (see step 410).

In yet further embodiments, the method may further comprise moving the locking member into an unlocked configuration by pushing on the actuator portion of the locking member (see step 412).

In any embodiment, the method may further comprise rotating the valve body until the valve body is in a locked or unlocked position (see step 414).

While most embodiments have been directed to those powered hydraulically, other powered hammer assemblies and powered tool assemblies are considered to be within the scope of the present disclosure including those that are mechanically or electrically driven, etc. Similarly, the embodiments discussed herein are typically cylindrical in configuration but other configurations are considered to be within the scope of the present disclosure.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein.

It will be apparent to those skilled in the art that various modifications and variations can be made to the embodiments of the apparatus and methods of assembly as discussed herein without departing from the scope or spirit of the invention(s). Other embodiments of this disclosure will be apparent to those skilled in the art from consideration of the specification and practice of the various embodiments disclosed herein. For example, some of the equipment may be constructed and function differently than what has been described herein and certain steps of any method may be omitted, performed in an order that is different than what has been specifically mentioned or in some cases performed simultaneously or in sub-steps. Furthermore, variations or modifications to certain aspects or features of various embodiments may be made to create further embodiments and features and aspects of various embodiments may be added to or substituted for other features or aspects of other embodiments in order to provide still further embodiments.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A locking valve body assembly for use with a powered hammer assembly, the valve body assembly comprising:
a valve body that defines a circumferential direction, a radial direction and a longitudinal axis, a void configured to contain a pressurized fluid;
a cylinder configured to receive the valve body, the cylinder defining a radially extending locking aperture on it circumferential surface; and
a latch mechanism including
a radially extending locking member;
a spring biasing the locking member into the radially extending locking aperture of the cylinder; and
an actuator configured to move the locking member radially inward.

2. The locking valve body assembly of claim 1 wherein the locking member includes a main body extending radially through the locking aperture and the actuator extends radially from the main body past the circumferential surface of the cylinder and the actuator is integral with the main body of the locking member.

3. The locking valve body assembly of claim 1 further comprising a keeper disposed radially inward to the locking member and being configured to limit the radial inward movement of the spring and the locking member.

4. The locking valve body assembly of claim 2 wherein the locking member further comprises a hook portion and the valve body further defines a pocket configured to receive the hook portion of the locking member.

5. The locking valve body assembly of claim 4, wherein the valve body further comprises a retaining flange and the retaining flange defines the pocket configured to receive the hook portion of the locking member.

6. The locking valve body assembly of claim 3, wherein keeper defines a ledge disposed radially inward of the locking member, the ledge being configured to abut the rear of the locking member as radially inward force is exerted on the actuator.

7. The locking valve body assembly of claim 6 wherein the keeper is attached to the cylinder.

8. The locking valve body assembly of claim 1 wherein the locking member defines an aperture configured to receive the spring.

9. The locking valve body assembly of claim 4, wherein the actuator and hook portion of the locking member both face radially outwardly.

10. A powered hammer assembly comprising:
a housing;
a power cell that includes a piston; and
a locking valve body assembly that includes:
a valve body that defines a void that is configured to contain a pressurized fluid;
a latch mechanism including a locking member and a spring configured to bias the locking member radially into a locking configuration; and
a retainer member;
wherein the housing defines a first aperture that is configured to receive the locking member, and wherein the housing further defines a retaining slot that is configured to receive the retainer member.

11. The powered hammer assembly of claim 10 wherein the valve body and the retainer member define an axis of rotation, a circumferential direction and a radial direction and the locking member is configured to translate in the radial direction.

12. The powered hammer assembly of claim 11 wherein the valve body and retaining member are integral with each other.

13. The powered hammer assembly of claim 12 wherein the retainer member defines a pocket that is configured to receive the locking member and a circumferential slot that is configured to allow the valve body to rotate when the locking member is not in a locking configuration.

14. The powered hammer assembly of claim 13 further comprising a keeper that is disposed in the circumferential slot radially inward of the spring and the locking member.

15. The powered hammer assembly of claim 14, wherein the locking member includes a main body portion defining an inside radial end, a hook portion extending from the inside radial end, an outside radial end, and an actuation portion extending from the outside radial end.

16. A method of retaining and removing a valve locking body from a powered hammer assembly, the method comprising:
inserting a locking member into a radially extending aperture of a cylinder;
inserting a spring until the spring contacts the locking member; and
inserting a keeper radially inwardly of the spring and the locking member and attaching the keeper to the cylinder.

17. The method of claim 16 further comprising trapping the spring between the keeper and the locking member.

18. The method of claim 16 further comprising biasing the locking member into a locked configuration.

19. The method of claim 17 further comprising moving the locking member into an unlocked configuration by pushing on the actuator portion of the locking member.

20. The method of claim 19 further comprising rotating the valve body until the valve body is in a locked or unlocked position.
